(19) United States
(12) Patent Application Publication
(10) Pub. No.: US 2013/0042481 A1
(43) Pub. Date: Feb. 21, 2013

(54) Hair trimming apparatus with light

(71) Applicants: Lori Ann Lombardo, East Hanover, NJ (US); Lana Rascionato, Totowa, NJ (US); Anand Khubani, Towaco, NJ (US)

(72) Inventors: Lori Ann Lombardo, East Hanover, NJ (US); Lana Rascionato, Totowa, NJ (US); Anand Khubani, Towaco, NJ (US)

(21) Appl. No.: 13/199,022

(22) Filed: Aug. 17, 2011

(51) Int. Cl. B26B 19/46

(52) U.S. Cl. 30/34.05

(57) ABSTRACT

A hair trimming apparatus is provided, the apparatus comprises: a housing having a top end; a head pivotally attached to the top end of the housing, and the head comprises at least one cutting element; at least one light source attached to the head or housing to illuminate the apparatus and user's target area during use; a motor for moving the cutting element; and a power source for operating the motor and activating the light source.

### BACKGROUND OF THE INVENTION

1. Field of the Invention

This invention relates to a hair trimming apparatus and more specifically, a hair trimmer with a pivoting head and lights.

2. Description of the Related Art

There are various patents covering hair trimming and cutting devices. The present invention provides for a hair trimming apparatus with lights and specifically, with a lighted head.

### SUMMARY OF THE INVENTION

In one embodiment, the present invention provides for a hair trimming apparatus comprising: a housing having a top end; a head pivotally attached to a portion of the top end of the housing, and the head comprises at least one cutting element; at least one light source attached to a portion of the head to illuminate the head during use; a motor for moving the cutting element; and a power source for operating the motor and/or the light source.

In another embodiment, a portion of the head has a transparent element that allows for the illumination of the light from the light source. In a further embodiment, the light source is selected from a group consisting essentially of a light bulb, an LED and combinations thereof. In yet another embodiment, a portion of the head has a translucent element that allows for the illumination of the light from the bulb. In still another embodiment, head further comprises a reflective element for reflecting the light emitted by the light source. In another further embodiment, the reflective element or material is situated adjacent the light source.

In still yet another embodiment, the power source is a battery. In a further embodiment, the housing comprises an internal cavity. In another further embodiment, the power source is situated within the internal cavity of the housing. In yet a further embodiment, the motor is situated within the internal cavity of the housing.

In still a further embodiment, the apparatus further comprises an on/off switch. In still yet a further embodiment, the apparatus 1 further comprises a cap, and the cap is designed to cover the head during non-use. In another embodiment, the apparatus further comprises an attachment comb.

In yet another embodiment, the present invention provides for a hair trimming apparatus comprising: a housing having top and bottom ends, the bottom end functioning as a handle and the top end defining a head; at least one cutting element attached to the head; at least one light bulb designed to illuminate the head to illuminate the head during use; a motor for moving the cutting element; and a power source for operating the motor.

In still another embodiment, the power source is a battery. In still yet another embodiment, the housing comprises an internal cavity. In a further embodiment, the power source is situated within the internal cavity of the housing. In another further embodiment, the motor is situated within the internal cavity of the housing.

In yet another further embodiment, the light bulb is situated adjacent the head. In still another further embodiment, the light bulb is situated on the housing. In still yet another further embodiment, the apparatus further comprises a cap to cover the head during non-use and an attachment comb. In another further embodiment, the cap prevents an on position and keeping the apparatus in an off position. cutting element is removable from said head.

In another embodiment, the cutting element is removable from the head and the apparatus further comprises a mechanism for locking and unlocking the cutting element to and from the head. In yet another embodiment, the apparatus further comprises a sleeve designed to cover a portion of the housing and function as a grip.

In another further embodiment, the apparatus further comprises an element for turning the light source on and off. In still another embodiment, the apparatus further comprises an on/off switch with a three mode function, the first mode is in an off position, the second mode activating the cutting element and the third mode activating the cutting element and the light source.

In another embodiment, the present invention relates to a hair trimming apparatus comprising: a housing having a top end, and the housing having a cavity and functioning as a handle; a head attached to at least a portion of the top end of the housing, the head is movable to create various angles during use, the head comprises at least one cutting element; at least one light source attached to at least a portion of the housing; a motor for moving the cutting element; and a power source for operating the motor and activating the light source, the power source is situated within the cavity of the housing.

In another embodiment, the light source may be placed anywhere on the housing to illuminate the head and/or the cutting element. In a further embodiment, the cutting element comprises one or more blades.

In another further embodiment, the head is stationary relative to the housing. In yet another further embodiment, the head is rotatably attached to a pivot point on the top end of the housing. In still another further embodiment, the head moves to various angles relative to the housing to allow the cutting elements to cut hair in touch to reach places.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is perspective views of the hair trimming apparatus of the present invention with cap removed;

FIG. 2 is perspective views of the apparatus of FIG. 1 with cap attached;

FIG. 3 is a side view of the apparatus showing movement of the head;

FIG. 4 is an exploded view of the apparatus;

FIG. 5 is a perspective view of another embodiment of the apparatus; and

FIG. 6 is a perspective view of further embodiment of the apparatus.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

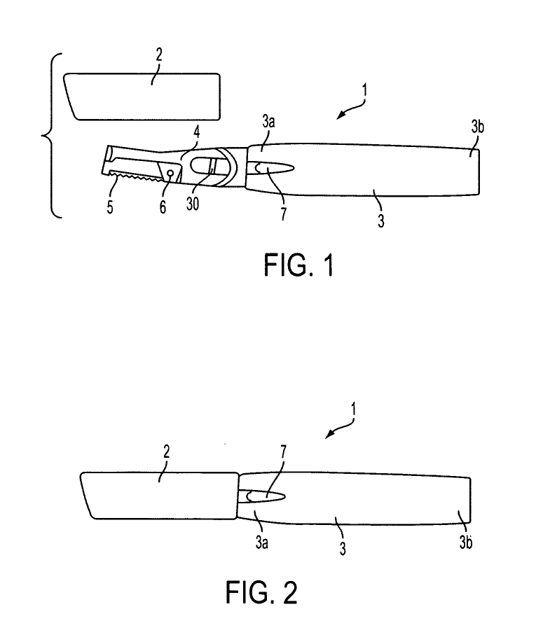

FIGS. 1-2 illustrate an apparatus 1 comprising a housing 3 with top and bottom ends, 3a and 3b respectively, and a head 4 pivotally attached to the top end 3a of the housing 3. The bottom end 3b of the housing 3 may function as a handle for the user. There is a cutting implement or blade or razor 5 attached to the head 4 of the apparatus 1. The sharp edges of the razor 5 protrude from a portion of the head 4 of the apparatus. A light 6 is also situated on the head 4 of the apparatus 1. There is a cap 2 which fits over the head during non-use, storage or transport as shown in FIG. 2. The cap 2 is removed from the head 4 to expose the razor 5 as shown in FIG. 1. There is an activation switch or on/off switch 7 situated on the housing 3. The switch 7 activates the motor (not shown) which moves the razor 5 which allows for the cutting of hair and also activated the light 6 which illuminates the head 4 and target area of the razor 5. There is a locking mechanism 30 which allows for access to the removable razor 5 for cleaning or replacement of the blade.

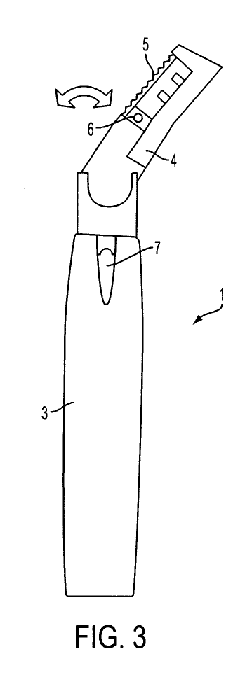

FIG. 3 shows the movement of the pivoting head 4. In one embodiment, the head 4 with the light 6 moves a minimum of approximately 45 degrees or less. In another embodiment, the head 4 moves a minimum of approximately 30 degrees or less. In yet another embodiment, the head 4 starts at a position that is parallel to the housing 3. In still another embodiment, the head 4 moves over 180 degrees. The head 4 is pivotally attached to the housing 3 which provides for various angles for shaving. In a further embodiment, there is no limitation to the angles created by the movement of the head 4 relative to the housing 3. The light 6 is situated adjacent the razor 5 to allow for the illumination of the target area for shaving.

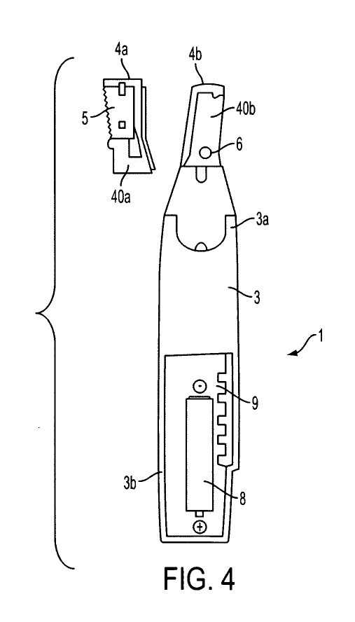

FIG. 4 relates to a cutaway view of the apparatus 1 which shows the top end 3a and bottom end 3b of the housing 3, and the top end 3a is pivotally attached to a head 4 which has two portions, 4a and 4b respectively. The first portion houses the removable razor 3 and the second portion has a transparent or translucent element 11 situated adjacent the light source 6. The light source 6 may be a bulb or LED. The housing 3 has a cavity 9 that stores the power source or battery 8 adjacent the bottom end 3b of the housing 3. The head 4, in one embodiment, comprises a removable component 40a and a second component 40b. The razor or blade 5 is situated in between the removable component 40a and the second component 40b of the head 4 during assembly.

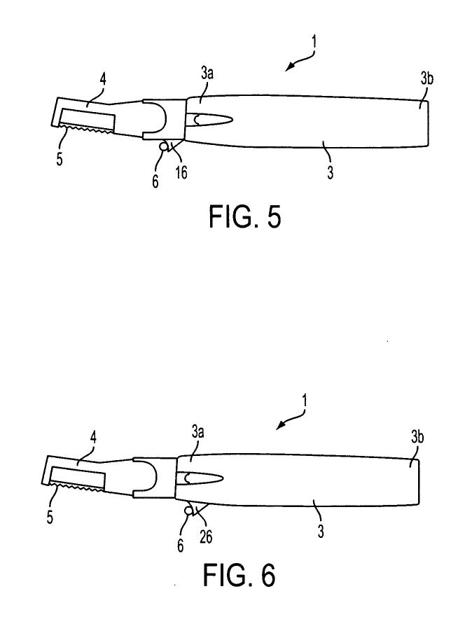

FIG. 5 depicts another embodiment of the present invention showing the light source 6 attached to an exterior light housing 16 which is situated on the head 4 of the apparatus 1. The light source 6 may be pointed at the razor 5 and/or the target area for shaving.

FIG. 6 illustrates a further embodiment of the present invention showing the light source 6 attached to an exterior light housing 26 which is attached to the housing 3. The light source 6 may be pointed at the razor 5 and/or the target area for shaving.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A hair trimming apparatus comprising:
a housing having a top end;
a head pivotally attached to at least a portion of said top end of said housing, said head comprising at least one cutting element;
at least one light source attached to at least a portion of said head to illuminate said head during use;
a motor for moving said cutting element; and
a power source for operating said motor and illuminating said light source.

2. The apparatus of claim 1 wherein a portion of said head has a transparent element that allows for the illumination of the light from said light source.

3. The apparatus of claim 1 wherein a portion of said head has a translucent element that allows for the illumination of the light from said light source.

4. The apparatus of claim 1 wherein said head further comprises a reflective element for reflecting the light emitted by said source.

5. The apparatus of claim 1 wherein said power source is a battery.

6. The apparatus of claim 1 wherein said housing comprises an internal cavity.

7. The apparatus of claim 6 wherein said power source is situated within said internal cavity of said housing.

8. The apparatus of claim 6 wherein said motor is situated within said internal cavity of said housing.

9. The apparatus of claim 1 further comprises an on/off switch.

10. The apparatus of claim 1 further comprises a cap, said cap designed to cover said head during non-use, said cap preventing an on position and keeping said apparatus in an off position.

11. The apparatus of claim 1 further comprising an attachment comb.

12. The apparatus of claim 1 wherein said light source is an LED light.

13. The apparatus of claim 1 wherein said light source is a light bulb.

14. The apparatus of claim 1 wherein said cutting element is removable from said head.

15. The apparatus of claim 14 further comprising a mechanism for locking and unlocking said cutting element to and from said head.

16. The apparatus of claim 1 further comprising a sleeve designed to cover a portion of said housing and function as a grip.

17. The apparatus of claim 9 further comprising an element for turning said light source on and off.

18. The apparatus of claim 17 wherein said on/off switch comprises a three mode function, said first mode being in an off position, said second mode activating said cutting element and said third mode activating said cutting element and said light source.

19. A hair trimming apparatus comprising:
a housing having top and bottom ends, said bottom end functioning as a handle and said top end defining a head;
at least one cutting element attached to at least a portion of said head;
at least one light source designed to illuminate said head to illuminate said head during use;
a motor for moving said cutting element; and
a power source for operating said motor and said light source.

20. The apparatus of claim 19 wherein said power source is a battery.

21. The apparatus of claim 19 wherein said housing comprises an internal cavity.

22. The apparatus of claim 19 wherein said power source is situated within said internal cavity of said housing.

23. The apparatus of claim 21 wherein said motor is situated within said internal cavity of said housing.

24. The apparatus of claim 19 wherein said light source is situated adjacent said head.

25. The apparatus of claim 19 wherein said light source is selected from a group consisting essentially of LED light, light bulb and combinations thereof.

26. The apparatus of claim 19 further comprising a cap to cover said head and an attachment comb.

27. A hair trimming apparatus comprising:
a housing having a top end, said housing having a cavity and functioning as a handle;
a head being attached to at least a portion of said top end of said housing, said head being movable to create various angles during use, said head comprising at least one cutting element;
at least one light source attached to at least a portion of said housing;
a motor for moving said cutting element; and
a power source for operating said motor and said light source, said power source being situated within said cavity of said housing.
